(19) United States
(12) Patent Application Publication
(10) Pub. No.: US 2009/0034843 A1
(43) Pub. Date: Feb. 5, 2009

(54) DEVICE FOR AND METHOD OF DISPLAYING USER INFORMATION IN A DISPLAY

(75) Inventors: Dolf Wittkamper, Best (NL); Wendy Persoon, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/063,856

(22) PCT Filed: Aug. 1, 2006
(86) PCT No.: PCT/IB06/52619

§ 371 Date: Feb. 15, 2008

(30) Foreign Application Priority Data
Aug. 18, 2005 (EP) 05107595.0

(51) Int. Cl. G06K 9/00

(52) U.S. Cl. 382/181

(57) ABSTRACT

The invention relates to a device (DEV), comprising a display (DIS) for displaying user information (inf). The device (DEV) is adapted to identify regions (REG) on the display (DIS) being hidden by an object (OBJ) in front of the display (DIS). According to the invention, the user information (inf) is arranged in the display (DIS) outside of the region (REG) hidden by the object (OBJ) so that a user can read the whole user information (inf). Furthermore, the invention relates to a method of displaying user information (inf) in a display (DIS). Finally, the invention relates to a transponder (OBJ), in particular to an RFID tag, which comprises means for storing object information (oif) related to the size and/or shape and/or graphical representation of the transponder (OBJ).

### FIELD OF THE INVENTION

The invention relates to a device having a display for displaying user information. The invention also relates to a method of arranging user information in a display and finally to a transponder.

### BACKGROUND OF THE INVENTION

Normally, displays are just for displaying information. In addition, there are also solutions where the display is “interactive”, meaning that the displayed information also serves as an input interface. One example is a touch screen where virtual buttons, which also may change, are displayed. When a user presses such a button a predefined action is performed.

Usually, buttons have a certain size, geared to a user's finger. Hence, there is no real need for changing the size of a button since the size of a user's finger is more or less constant. A different situation is found if objects of different size are placed on or in front of a display for interaction.

One example is a device which has a display and an antenna for radio communication arranged in such a manner that radio communication with a second device may take place when the second device is held in front of the display. Known systems, for instance, have windings of a conductor on the outer edge of the display, which serve for inductive coupling to a transponder. Just for imagination, reference is made to the entrance of a cinema. On the display the following exemplary information is shown: “Please hold your voucher, your ticket, your cash card or your credit card in front of the display”. As one can imagine, all listed objects may have different size and shape. In addition, a credit card, for example, may also be incorporated in a mobile phone with a NFC interface (“Near Field Communication”) which makes the situation more complicated, as each phone differs in size and shape. Moreover, the object may be presented to the display at any location in any orientation. If additional information, such as: “You are booked for movie xy, please proceed to hall z” in addition with an image of a corresponding movie poster, is subsequently displayed, it is not clear if the user is able to see the information. This is easy to understand because the user hides a region of the display with, for example, his ticket, which is equipped with an RFID tag (“Radio Frequency Identification”) storing data for entering the cinema.

A second example is the use of a transponder or RFID tag as a “media tag”. Such a media tag can store—if it contains sufficient memory—content such as music or video, which may be processed and played with a media player, such as a music or video player. Such a media tag may be incorporated into a “carrier” to provide better handling for a user. Just for imagination, a disk-shaped carrier with a diameter of some centimeters (a “button”) is mentioned. In addition, an image of the cover of a music album or movie may be printed on the carrier. The media player itself again comprises a display and a radio antenna around it.

To transmit the content stored on the media tag, said media tag or respectively the corresponding carrier is placed close to the antenna of a reader, which reader is connected to the player. The content is then transmitted to the reader and from there to the player and usually stored in a memory of the player.

The media player comprises a display for displaying user information (which, for example may be associated with the content stored in the media tag). When placing the media tag in front of said display to establish a connection between the media tag and the reader of the player, again at least a part of the information displayed in the display is hidden by the object so that it is difficult or impossible for a user to read the whole information in the display.

### OBJECT AND SUMMARY OF THE INVENTION

It is now an object of the invention to provide a device, a method, and a transponder of the type mentioned in the opening paragraph, which obviate the drawbacks described above.

To achieve the object described above, a device is disclosed, comprising a display for displaying user information, region detecting means for detecting one or more regions of the display being hidden by at least one object in front of said display, and user information arranging means for arranging said user information in the display outside of the at least one region being detected with the aid of said region detecting means.

Furthermore, the inventive object is achieved by a method of arranging user information in a display, wherein one or more regions of the display being hidden by at least one object in front of said display is/are detected, and, subsequently, said user information is arranged in the display outside of the at least one region being detected.

The inventive object is finally achieved by a transponder, comprising memory means for storing object information, which object information is related to a) the size and/or the shape of said transponder, and/or b) a graphical representation of the transponder, and transmitting means for transmitting said object information to a remote device.

The provision of the characteristic features according to the invention offers the advantage that the user information, which is displayed in the display, is arranged in such a way that an object in front of or on the display does not hide said user information or a part of said user information. Thus a user may recognize the whole user information displayed in the display although an object is in front of or on the display. If the display is big enough, this is an easy task. Here the information is rearranged, so that it fits in the remaining display space. One further solution is to shrink the information as a whole and rearrange it. The necessary reduction ratio can roughly be calculated by dividing the size of the original region by size of the remaining region. Another solution is to reduce the spaces between the different elements of the information, that is to say the line spaces, space between text and images and, in particular, the outer border of the displayed information, since quite often not the whole display is indeed used for displaying information. Yet another solution is to shift a part of the information out of the display and make it accessible by means of well-known scroll bars.

It should be noted that the invention does not only refer to devices with a display and radio communication means. It is rather imaginable that data from an object in front of a display is transmitted by means of other techniques. One example is a device having a display and a camera. In this way, it would be possible to read a bar code from a ticket, which is presented in front of or on top of a display. A second example is infrared data communication from a mobile phone to a kiosk system. The receiver may also be arranged opposite of the display so that data is transmitted away from the display. Coming back to the bar code on a ticket, this means that the ticket has to be placed onto the display in such a way that the bar code remains visible for the user (and the camera). Data may also be transmitted in both directions, that is to say from the object in front of the display to the device comprising the display and vice versa, for example to download music from a kiosk into a MP3 player, which is presented in front of the display of the kiosk.

Finally, it should be noted that advantageous embodiments and advantages disclosed with reference to the inventive device are equally applicable to the inventive method and vice versa.

A solution according to which the region detecting means comprise tactile information recognizing means for recognizing tactile information on the display provides a simple and effective realization of the invention for situations where the object is positioned directly on the display. For example a well known touch screen can be used, which touch screen only has to be adapted in such a way that a region touched by an object can be identified so that the information to be displayed may be arranged accordingly.

In an alternative solution the region detecting means comprise optical information recognizing means. Such a solution offers the advantage that on the one hand it is not necessary that the object touches the display for identifying regions being hidden by the object, and on the other hand the whole shape of the object may be detected and can be taken into account when evaluating the region(s) being hidden by the object. Such a solution is more complicated to realize, but usually better results may be obtained.

The optical information evaluating means are commonly realized in the form of one or more cameras. For example, there are kiosk systems or public Internet access points, which are constructed in a special way so as to be protected against vandalism. Here a video projector generates an image on a simple plate, which reflects said image and in this way serves as a “monitor”. At the same time a camera registers any movement of a user's hand over said plate. In this way a user can “press” a virtual button, which is projected on the plate. This technique is also known as “gesture control”. Normally, video projector and camera are mounted above said plate, but also horizontal arrangements and even arrangements where the projector and/or the camera are behind a semi-transparent plate are imaginable. It is further imaginable that an antenna for radio communication is embedded in the plate. In this way, data (e.g. from a voucher or ticket comprising a RFID-tag or from a mobile phone equipped with an NFC-interface) can easily be transmitted into the system. It is understandable that the principles of the invention also apply to such a “display”.

In another solution where the region detecting means comprise radio data receiving means for receiving radio data comprising object information concerning the size and/or shape of an object in front of the display, the advantage is offered that it is not necessary to determine the shape and/or size of an object in front of the display, since object information concerning the size and/or shape of said object is provided by the object itself.

Furthermore, if the radio data receiving means comprise at least one antenna for locating an object in front of the display the advantage is offered that this is a comparable simple technique for locating objects. A very simple solution is an arrangement where a single antenna covers only a part of the display. Here the position of an object is given by the position of the antenna. It is very advantageous if the radio receiving means comprise at least two antennas for locating an object because of the improved resolution. In general, a higher number of antennas leads to a higher resolution. A very common solution here is a column-row arrangement. For example, a matrix of 16 fields can be build up of 4 column antennas and 4 row antennas. It is needless to say that also 16 separate antennas arranged in a matrix would be possible. In this context, reference is also made to the non-published patent application EP 05102965.0, which hereby is incorporated by reference. Said patent application offers a method to locate objects with a lower number of antennas compared to a row-column arrangement.

The different solutions described above are usually designed to be used independently. However, it may also be of advantage that two or all three different solutions are used in combination to obtain an optimal result when detecting an object in front of the display and determining (a) region(s) being hidden by said object in front of the display.

Additionally, it is beneficial if the device comprises graphical representation determining means for determining a graphical representation of an object in front of the display, and if the device further comprises graphical representation means for representing said graphical representation of the object in the display. This solution provides the advantage that a graphical representation of the object (e.g., the transponder) can be displayed on the display so that a user is able to easily identify the data stored in the device. An example is a media player, e.g. in the home environment, which is able to play music or also videos, which are stored on a RFID tag. The RFID tag itself has the shape of a small disk so as to provide for better handling. Additionally a unique picture, e.g. the cover of an album or of a movie, is printed on the disk so that the user can visually identify the RFID tags. When the music is to be played, he holds the disk in front of the display. Subsequently data is transmitted from the RFID tag in the disk to the media player. When the data transmission is finished, the user takes the disk away again. Now an image of the disk, usually the one which is printed on the disk, is displayed on the display. Hence, a user can easily see which album or movie is currently being played.

Furthermore, a solution is beneficial where the graphical representation means are designed to present the graphical representation of the object in the region of the display detected with the region detecting means. Thereby the advantage is provided that the user information still may be displayed completely in the display even when the object is taken away since the graphical representation of the object is displayed at the same location where the object (transponder) was before. With regard to the example above, this means that the image of the disk is displayed at the same location where the disk was held.

A solution where said graphical representation determining means are realized by the optical information recognizing means offers the advantage that an actual image of the object in front of the display can be shown in the display, for example by simply taking a photograph of the object with the optical information recognizing means (camera).

Other solutions of the invention where said graphical representation determining means are realized by the radio data receiving means, provide the advantage that its realization is simple and that a predefined representation of the object may be displayed in the display. Coming back to the media player mentioned before, the image of the transponder, which is displayed on the display, is stored in the transponder itself and transmitted to the media player on demand. Hence the media player does not need optical recognition means to determine the optical representation of the transponder. An example is a simple GIF image of the transponder.

It is also very beneficial if the steps of detecting one or more regions of the display being hidden by at least one object in front of said display and arranging said user information in the display outside of the at least one region being detected are repeated cyclically. By doing so, the information is adapted and rearranged to the available space if a object is repositioned on the display surface.

These and other aspects of the invention are apparent from and will be elucidated with reference to the embodiments described hereinafter.

### BRIEF DESCRIPTION OF THE DRAWINGS

The invention will be described in detail hereinafter, by way of non-limiting example, with reference to the embodiments shown in the drawings.

FIG. 1 shows a device with a display and the arrangement of user information in the display.

FIG. 2 shows the device of FIG. 1 with an object in front of the display.

FIG. 3 shows the arrangement of user information in a display according to the situation as shown in FIG. 2.

FIG. 4 shows another arrangement of user information in a display.

FIG. 5 shows a block diagram of the basic arrangement of a device according to the invention.

FIG. 6 shows a first embodiment of an arrangement according to FIG. 5.

FIG. 7 shows a second embodiment of an arrangement according to FIG. 5.

FIG. 8 shows a third embodiment of an arrangement according to FIG. 5 and additionally an object according to the invention in front of the display.

FIG. 9 shows a fourth embodiment of an arrangement according to FIG. 5.

### DESCRIPTION OF EMBODIMENTS

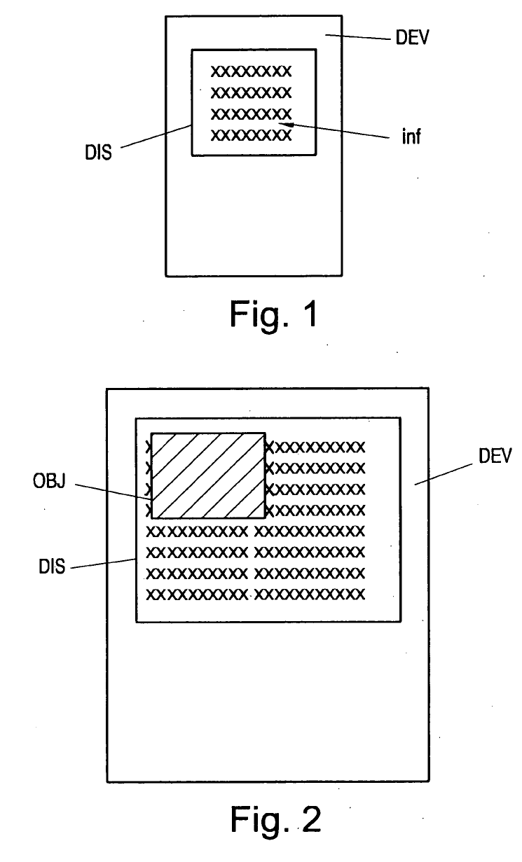

FIG. 1 shows a device DEV such as a kiosk system or a media player with a display DIS. User information inf is displayed in the display DIS of the device DEV. The user information inf can be arbitrary information. However, usually the user information will contain information such as a title of a music file etc. reproduced with the device DEV.

FIG. 2 shows the device DEV of FIG. 1 with an object OBJ in front of the display DIS. The object OBJ may be an arbitrary object. However, usually the situation as shown in FIG. 2 occurs when the object OBJ is a transponder, which stores data which are provided to be transmitted to the device DEV. The device DEV then comprises means for reading data from the object OBJ, for example the device DEV comprises a RFID-reader (not shown). But also other data transmission techniques are possible as mentioned before. As can be seen from FIG. 2, the object OBJ in front of the display DIS covers a certain region of the display DIS so that user information inf arranged behind the object OBJ is not visible for a user of the device DEV.

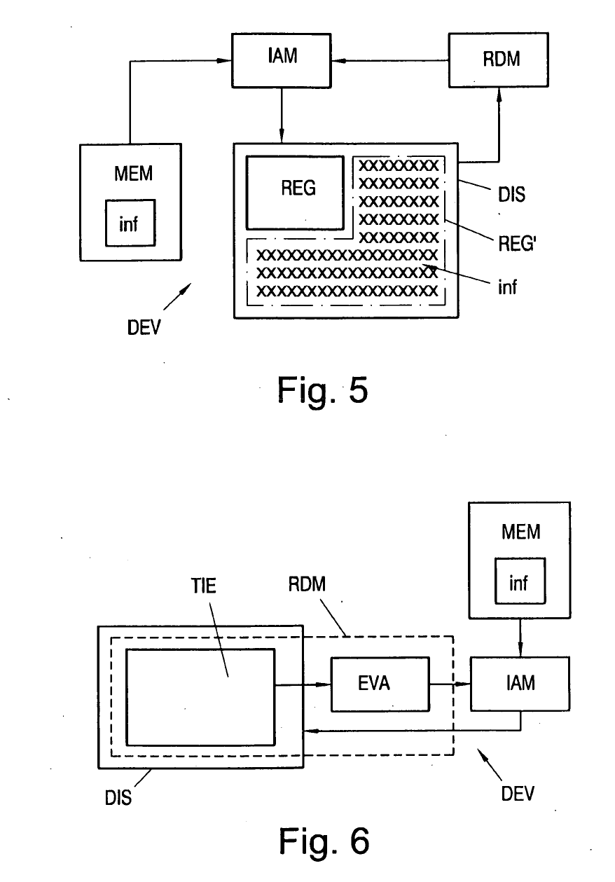

With a display DIS according to the invention, which will be described in detail in FIG. 5-FIG. 9, it is possible to detect the regions REG, which are covered by an object OBJ in front of the display DIS. The user information inf is then arranged in the remaining region REG′ of the display DIS so that a user can read the whole user information inf.

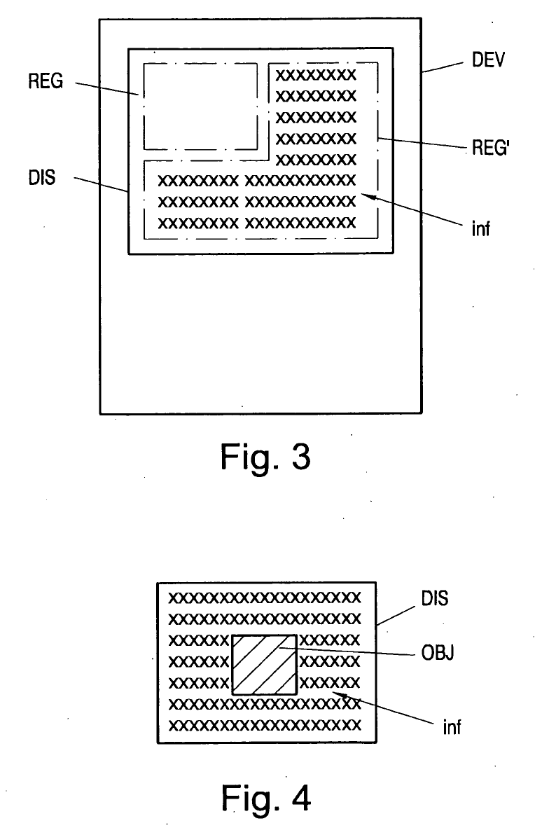

FIG. 3 shows an example where one region REG is covered by an object OBJ. The user information inf is then arranged in the remaining region REG′.

FIG. 4 shows another situation where the object OBJ is situated in another position in front of the display DIS, and the corresponding arrangement of the user information inf in the remaining region REG′ of the display DIS.

FIG. 5 shows the basic arrangement of a device DEV for displaying user information inf according to the invention. The device DEV comprises a display DIS and region detecting means RDM for detecting one or more regions REG of the display DIS being hidden by at least one object OBJ in front of said display DIS. Furthermore the device DEV comprises user information arranging means IAM for arranging said user information inf in the display DIS outside of the at least one region REG being detected with the aid of said region detecting means RDM. In the example shown in FIG. 5 the user information arranging means IAM are connected with memory means MEM, which memory means MEM store the user information inf to be displayed in the display DIS.

The function of the arrangement shown in FIG. 5 is as follows: It is presumed that at first no object OBJ is presented in front of the display DIS. User information inf is therefore read out of the memory means MEM and output to the display DIS by the user information arranging means IAM. The user information arranging means IAM in this case serve as a conventional display driver. Therefore the whole display DIS is used for displaying user information inf (not shown in FIG. 5). Later an object OBJ is placed in front of the display DIS. The region detecting means RDM detect this changing and determine size, shape and position of the object OBJ. This information is passed to the user information arranging means TAM, which in turn rearrange the user information inf on the display DIS.

However, it should be noted that the invention is not restricted to specific user information inf and also not to the kind of storing and/or retrieving of the user information inf. For example, the user information inf may also be transmitted by an object OBJ (transponder) to the display DIS where the user information inf is then displayed. In this case no memory means MEM would be necessary for storing the user information inf.

FIG. 6 shows an embodiment of the invention where the region detecting means RDM comprise tactile information recognizing means TIE for recognizing tactile information on the display DIS and object information evaluating means EVA for evaluating the tactile information on the display DIS. A well-known implementation of a display DIS combined with tactile information recognizing means TIE is a touch screen. By evaluating the tactile information, which is provided by the object OBJ when it is pressed on the touch screen, it is possible to detect the region(s) REG on the display DIS being hidden by an object OBJ, and with the aid of the user information arranging means IAM the user information inf can be arranged outside of the hidden region REG as described before.

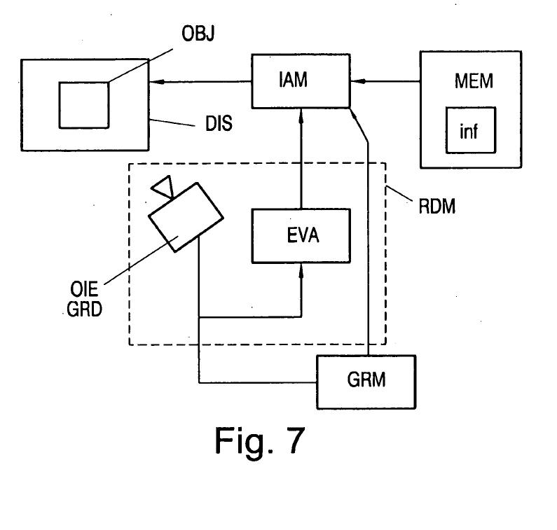

FIG. 7 shows an embodiment of the invention where the region detecting means RDM comprise optical information recognizing means OIE. Usually said optical information recognizing means OIE are realized in the form of one or more cameras. With said optical information recognizing means OIE it is possible to detect the size, shape and position of an object OBJ in front of the display DIS and with the object information evaluating means EVA it is then possible to determine the region(s) REG being hidden by the object OBJ.

In addition, the optical information recognizing means OIE (the camera) also serve as graphical representation determining means GRD. Therefore, the device DEV comprises graphical representation means GRM for extracting a graphical representation of the object OBJ out of the image output by said camera. This graphical representation is fed into the user information arranging means IAM, which generates an image to be output by the display DIS.

It should be noted that the entities in this and the other figures have a more or less functional meaning, which entities are not necessarily realized in separate physical blocks. It is rather possible that more than one function is performed by a single physical entity. Accordingly, one single function can be distributed over more than one physical entity. One example is the camera of FIG. 7, which serves for both functions, the optical information recognizing means OIE (for getting size, shape and position of the object OBJ) and the graphical representation means GRM (for getting an image of the object OBJ).

Reference is now made to the gesture control mentioned before. A video projector generates an image on a simple plate (both together can be seen as the display DIS), wherein at the same time a camera (optical information recognizing means OIE) registers any gesture of a user's hand over said plate and of course any object OBJ placed on top of the plate. Accordingly, user information inf is arranged in the remaining region REG′ of the display DIS. However, this embodiment of the invention is not limited to a projected image. It is rather imaginable that a camera is arranged opposite to a conventional display.

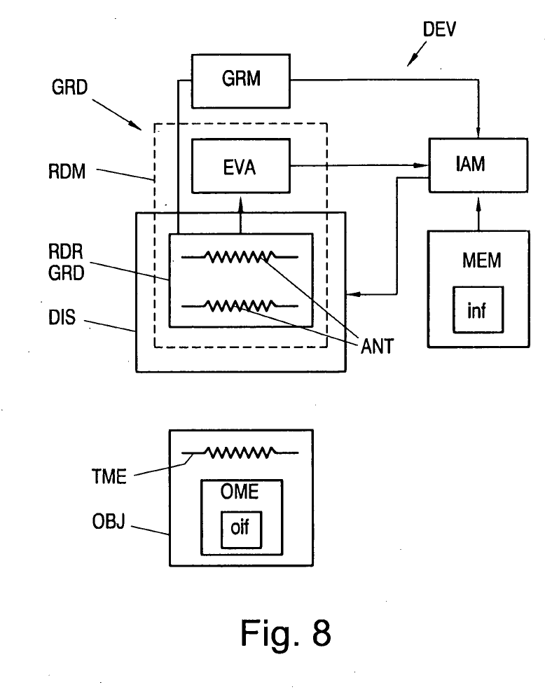

A further embodiment of the invention is shown in FIG. 8. Here the region detecting means RDM comprise radio data receiving means RDR for receiving radio data comprising object information oif concerning the size and/or shape of an object OBJ in front of the display DIS. The radio data receiving means RDR comprise at least one antenna ANT (shown symbolically) for locating the object OBJ in front of the display DIS.

In this case the object OBJ in front of the display DIS is a transponder (e.g. a RFID tag or a NFC device) comprising memory means OME for storing object information oif, which object information oif is related to the size and/or the shape of said device OBJ. Furthermore, the transponder comprises transmitting means TME for transmitting said object information oif to a remote device such as the radio data receiving means RDR. By means of the object information evaluating means EVA finally the region(s) REG being hidden by the object OBJ are determined by evaluating said object information oif.

Furthermore it is also possible to detect the orientation and distance of the object OBJ with respect to the display DIS with the radio data receiving means RDR, for example by a specific arrangement of antennas ANT.

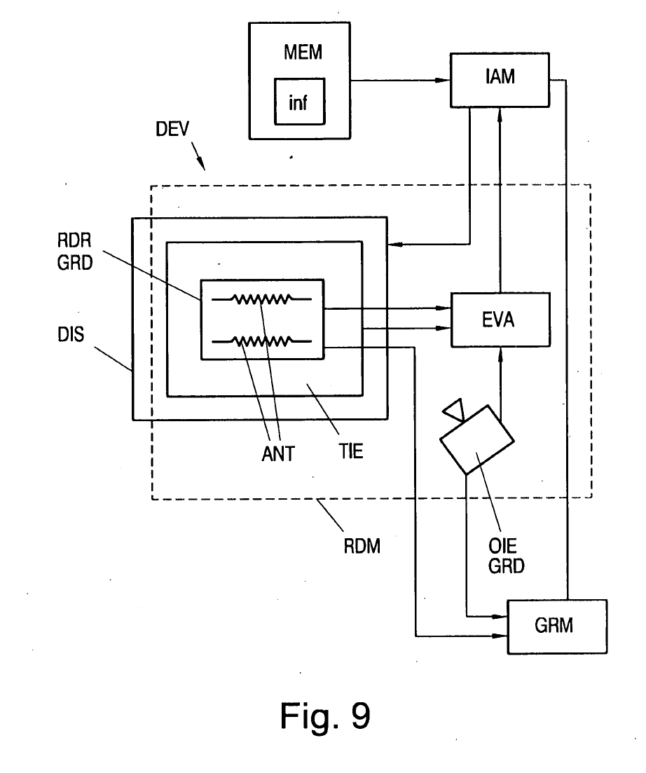

It is also possible to combine different solutions as mentioned above. Such a solution where all three different embodiments of the invention are used together is shown is FIG. 9. The combination of two or more embodiments according to the invention provides the advantage that the precision in determining the hidden region(s) may be increased significantly.

As mentioned before, it is sometimes desirable to display a graphical representation of the object OBJ (e.g., the transponder) in the display DIS so that a user for example is able to easily identify the data processed by the device DEV. This is of particular advantage if the object OBJ is removed from the display DIS after data transmission.

For these purposes, the display DIS comprises graphical representation determining means GRD for determining a graphical representation of an object OBJ, which in the present case are the radio data receiving means RDR and/or the optical information recognizing means OIE. In the first case (see also FIG. 7) it is possible to take, for example, an actual photo of the object OBJ, which may then be shown with the aid of the graphical representation means GRM in the display DIS. In the second case (see also FIG. 8) it is possible to receive from the object OBJ object information oif, which object information oif contains a graphical representation OGR, such as photograph or a symbol etc. of the object OBJ.

The region detecting means RDM in present case consist of the object information evaluating means EVA in combination with the tactile information recognizing means TIE and/or the optical information recognizing means OIE and/or the radio data receiving means RDR. The function of the arrangement shown in FIG. 9 is similar to the embodiments shown in FIGS. 6-8.

FIG. 9 shows a cumulative arrangement of possible measures or embodiments. In terms of reliability and accuracy of course a combination of all embodiments is useful, whereas it is easier to use necessary entities only with regard to technical concerns. Therefore a useful combination, for example, is a touch screen with an embedded RFID antenna. Here the tactile information recognizing means TIE of the touch screen serve for locating the object OBJ, whereas the radio data receiving means RDR provide information about the size, shape and graphical representation of the object OBJ. Another useful combination is a device where a camera serves for locating the object OBJ and for determining the size, shape and graphical representation of the object OBJ. It is needless to say that one skilled in the art can easily derive useful combinations from FIG. 9, which may be adapted to various applications.

In the context of this document the term “user information” also includes a so-called “user interface” on a touch screen which means that by touching specific symbols on the display a specific action is carried out by the device (for example, for dialing a telephone number, the user interface shows the word “call” and the number on the display). When an object such as a transponder is in front of the display the user interface will be arranged around the region covered by the object.

All of the above can also be applied to a large vertical display (e.g. active poster). The user (poster) information and can be represented around the location and shape of the carrier/mobile phone. The graphical representation of the carrier/mobile phone can then also be dragged over the surface to enable various actions (gaming, gathering info, making contact with others on the display, etc. . . . ) and thereby form an interactive electronic bulletin board.

In principle, the present invention applies to all devices comprising a display where it is possible that the display is (partly) covered by an object, in particular to devices comprising a display as well as an RFID reader. One skilled in the art easily can apply the present invention to a number of inventive devices, which range from a kiosk system (e.g. for purchasing products or tickets such as tickets for public transport), a vendor (e.g. for coffee), an entrance terminal (e.g. for cinemas), a (public) Internet access point, and an electronic poster up to devices which are rather placed in the home or office environment such as a media player (e.g. for music or videos), handheld devices (e.g. a mobile phone or a palmtop), TV sets, or even PCs. An inventive device may also be understood as a display module, which is to be built in a host device. An example is a touch-screen display module, which offers the inventive features and which, for instance, may be built into a vendor.

The invention is also applicable to arbitrary objects in front of the display. An electronic device such as a mobile phone can also be a carrier of a transponder and may also be placed on or before the display of the reader. The information on the display will then be displayed around the shape of the phone. Further objects to be presented in front of a display may be credit cards, cash cards, vouchers, tickets and devices which have an interface for data transmittal such as mobile phones or palmtops (e.g. with NFC interface, Bluetooth interface or infrared interface).

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The words “comprising” and “comprises”, and the like, do not exclude the presence of elements or steps other than those listed in any claim or the specification as a whole. The singular reference to an element does not exclude the plural reference to such elements and vice-versa. In a device claim enumerating several means, several of these means may be embodied by one and the same item of software or hardware. The mere fact that certain measures are recited in mutually different dependent claims does not indicate that a combination of these measures cannot be used to advantage.

1. Device (DEV), comprising:
a display (DIS) for displaying user information (inf),
region detecting means (RDM) for detecting one or more regions (RAG) of the display (DIS) being hidden by at least one object (OBJ) in front of said display (DIS), and
user information arranging means (IAM) for arranging said user information (inf) in the display (DIS) outside of the at least one region (REG) being detected with the aid of said region detecting means (RDM).

2. A device (DEV) as claimed in claim 1, wherein said region detecting means (RDM) comprise:
tactile information recognizing means (TIE) for recognizing tactile information on the display (DIS) and/or
optical information recognizing means (OIE) and/or
radio data receiving means (RDR) for receiving radio data comprising object information (oif) concerning the size and/or shape of an object (OBJ) in front of the display (DIS).

3. A device (DEV) as claimed in claim 2, wherein the radio data receiving means (RDR) comprise at least one antenna (ANT) for locating an object (OBJ) in front of the display (DIS).

4. A device (DEV) as claimed in claim 1, wherein the region detecting means (RDM) comprise object information evaluating means (EVA) for evaluating tactile and/or optical information on an object (OBJ) in front of said display and/or for evaluating radio data comprising object information (oif) on the object (OBJ).

5. A device (DEV) as claimed in one of claims 1 to 4, further comprising:
graphical representation determining means (GRD) for determining a graphical representation of an object (OBJ) in front of the display (DIS) and
graphical representation means (GRM) for representing said graphical representation of the object (OBJ) in the display (DIS).

6. A device (DEV) as claimed in claim 5, wherein said graphical representation determining means (GRD) are realized by the optical information recognizing means (OIF).

7. A device (DEV) as claimed in claim 5, wherein said graphical representation determining means (GRD) are realized by the radio data receiving means (RDR).

8. A method of arranging user information (inf) in a display (DIS), wherein
one or more regions (REG) of the display (DIS) being hidden by at least one object (OBJ) in front of said display (DIS) is/are detected, and, subsequently,
said user information (in) is arranged in the display (DIS) outside of the at least one region (REG) being detected.

9. A method as claimed in claim 8, wherein a graphical representation of said object (OBJ) is determined and subsequently displayed in the display (DIS).

10. Transponder (OBJ) comprising
memory means (OME) for storing object information (oif), which object information (oif) is related to
a) the size and/or the shape of said transponder (OBJ), and/or
b) a graphical representation of the transponder (OBJ), and transmitting means (TME) for transmitting said object information (oif) to a remote device (DEV).
